(19) United States
(12) Patent Application Publication
(10) Pub. No.: US 2011/0268146 A1
(43) Pub. Date: Nov. 3, 2011

(54) GRAPHITE ELECTRODE WITH AN ELECTRICAL CONNECTING ELEMENT

(75) Inventors: Wolfgang Reiser, Otterberg (DE); Stefan Huwer, Geiselberg (DE)

(73) Assignee: EMS ELEKTRO METALL SCHWANENMUHLE GMBH, Schwanenmuhle (DE)

(21) Appl. No.: 13/143,957

(22) PCT Filed: Jan. 15, 2010
(86) PCT No.: PCT/EP10/50478

§ 371 Date: Jul. 11, 2011

(30) Foreign Application Priority Data
Jan. 15, 2009 (DE) 10 2009 000 242.1
Feb. 11, 2009 (DE) 10 2009 000 755.5

(51) Int. Cl. H05B 7/06; H01B 5/00

(52) U.S. Cl. 373/88; 174/133 R

(57) ABSTRACT

The invention relates to a graphite electrode with an electrical connecting element as well as to a furnace for graphitizing carbon-containing materials by means of such graphite electrodes. According to the invention, it was found that the drawbacks known from the prior art are eliminated by establishing an electrical connection between the graphite electrode and the connecting element by means of wedge-shaped contacting elements. The contact pressure between the contact element and the wedge-shaped surface on the graphite electrode required for electrical conductivity of the interface can be influenced by means of the wedge angle and the contact surface.

The invention relates to a graphite electrode with an electrical connecting element as well as to a furnace for graphitizing carbon-containing materials by means of such graphite electrodes.

In the conversion of amorphous carbon to polycrystalline graphite, furnaces are being used for graphitizing the carbon-containing materials. During graphitization, a conversion of amorphous carbon to polycrystalline graphite takes place by heating to approximately 3,000° C. under the exclusion of air. Heating the carbon-containing material is carried out by means of electrical current, with the current being supplied via movable graphite electrodes that protrude into the furnace at the end faces at the furnace head and are pressed onto the ends of the carbon-containing material. This is done by means of hydraulic presses disposed at the end faces, which press the graphite electrodes against the carbon-containing material in order to establish an electrical contact.

With regard to the introduction of the large current loads required for graphitization, there is the problem of the providing contact between the graphite electrodes and the power supply. Known designs of such large-surface contacts on graphite electrodes include, for example, laterally screwed-on metal contacts. The space required for screwing results in a large proportion of unused graphite that does not contribute to the contact geometry. This causes large recurring costs for the replacement of electrodes and utilizes only about 10% of the contact surface for the actual current transmission because of the large difference in resistance of the contact materials. Expressed simply, most of the current merely flows along the shortest way from the metal contacts via the graphite electrode to the carbon-containing material, and for a large part, the contact material is not used for the actual current transmission. Apart from the safety precautions required, there is also a considerable amount of time involved for manually screwing on the contacts. Automatic screwing is not customary because that would be a considerable construction effort with additional space requirements. In order to avoid these drawbacks, large-surface contacts pressed onto the end faces are common. Screwing them on is in this case not possible because the threaded rod cannot be passed through the graphite electrode, as in the contacts screwed on laterally. Thus, the contacts on the end faces must be pressed on. The process hydraulic system, which is present in any case, can be used for this purpose. However, the contact force is much too small for the contact pressure required, because of the proportional relationship between the requirement for current and force. Pressure cannot be increased arbitrarily, because the material located in the furnace would otherwise be destroyed. However, if the contact pressure is too low, there are relatively few stable electrical contact points, due to flatness tolerances and roughness. These few contact points must then transmit a particularly large amount of current, and local overheating occurs, so that these tips melt off, with other tips taking over the current and also melting off. By and by, such contact pairings degrade increasingly because, apart from oxidation of the surfaces, the contact force also lets up, among other things. This phenomenon is referred to as “micro hot spots”. In the case of unilateral or multilateral introduction of current, there is generally a very non-uniform current distribution. If current is collected only at a small surface area, due to unevenness, for example, the contact materials are heated very strongly at this location. In the case of graphite as a contact partner, the electrical resistance then decreases at that location, and an even stronger current flows which leads to an even stronger heating. Consequently, a large hot spot forms which can lead to the partial destruction of the material contacts concerned.

It is therefore the object of the invention to provide an improved graphite electrode with an electrical connecting element.

This object is achieved by a graphite electrode having the features of the main claim. Advantageous embodiments are the subject matter of the dependent claims.

According to the invention, it was found that the above-mentioned drawbacks are eliminated by establishing an electrical connection between the graphite electrode and the connecting element by means of wedge-shaped contacting elements. The contact pressure between the contact element and the wedge-shaped surface on the graphite electrode required for electrical conductivity of the interface can be influenced by means of the wedge angle and the contact surface. In contrast, the ratio of the contact pressure to the contact force in the case of the above-described large-surface contact can only be influenced by means of the surface area. Therefore, the contact pressure can be increased without an increased contact force, e.g. by mechanical presses, being required.

In an advantageous embodiment, it is provided that the contact elements are resiliently mounted in the connecting element, individually or in groups, preferably of 2-3 contacting elements. Thus, settlements or changes in position of the graphite electrode or of the connecting element caused by manufacturing tolerances or thermally induced expansion can be compensated. Moreover, each contacting element can have a certain clearance about all axes which enables the compensation of greater angular or positional tolerances. This is important in particular in the case where the wedge-shaped surfaces into which the contacting elements are inserted are directly carved out of the graphite of the graphite electrode. In the process, greater angular and positional tolerances and greater deviations occur due to thermal expansion. If, in contrast, the electrical connecting element were rigidly provided with a plurality of contacting elements, these angular and positional tolerances would prevent an equally optimal contact of all contacting elements. The result would be an non-uniform current distribution in, and introduction of current into, the graphite electrode. Even though the invention can also be realized with lamellar contacting elements, the contacting element is preferably formed by a single or several massive wedges or partial wedges. Massive contacting elements, e.g. of copper, can transmit more current than the otherwise customary contact lamellas, and can also tolerate a higher contact pressure. They do not deform as easily as lamellas or spring lamellas, and facilitate a better surface contact. Partial wedges can be resiliently connected and form a wedge which is spring-elastic in itself. The partial wedges can be connected, for example, by springs that extend perpendicularly to the direction of the wedge. These springs consist, for example, of spiral springs or springy material. The partial wedges can also be carved out of a massive wedge so that only a web of the wedge material remains in the center of the wedge.

Preferably, the wedge-shaped surfaces or counter-surfaces form a wedge angle. Experiments have shown a wedge angle of 5 to 45° to be particularly advantageous. In that case, a sufficiently high contact pressure arises between the surfaces in relation to the contact force. Due to the wedge-shaped design according to the invention, the contact force transmitted by the spring is deflected laterally onto the wedge-shaped surfaces and amplified according to the parallelogram of forces. The forces introduced into the graphite electrode at the end faces therefore remain comparatively small and a sufficient contact pressure is generated nevertheless.

Preferably, a flexible electrical conductor is directly connected to every single contacting element. This is necessary for compensating the spring travel and the clearance of the contacting elements and for the movement of the electrode. This can include stacked metal foils or metal mesh or cables which are each connected with one of the contacting elements or one of the groups of contacting elements.

Preferably, all contacting elements are arranged so as to point in the same direction. This makes easy insertion of all contacting elements into the wedge surfaces possible. In this case, the contacting element do not necessarily have to be parallel to each other.

If the wedge-shaped surfaces are preferably disposed on the end face of the graphite electrode, it becomes possible to use the hydraulic presses disposed at the end faces, which are present anyway and which press the graphite electrodes against the carbon-containing material in order to establish an electrical contact, also for pressing the connecting element against the wedge-shaped surfaces, which are located at the end faces, of the graphite electrode at the same time. Because of the wedge-shaped design, the hydraulic pressure, which in view of the carbon-containing material cannot be increased arbitrarily, is now completely sufficient for establishing a connection sufficiently capable of carrying current between the connecting element and the graphite electrode.

Due to the comparatively high electrical resistance of graphite in relation to copper, the current tends to take the shortest path through the graphite electrode, which is most often cuboid. In order to take this into account, the wedge-shaped surfaces are preferably disposed on the end faces of the graphite electrode in such a way that the result is a comparable electrical current in operation for all contacting elements, takingi into account the above-mentioned specific resistance of graphite. This is the case if all currents conducted through the different contacting elements are within a range of +/−20%. This mostly results in a centrosymmetrical or mirror-symmetrical arrangement, e.g. along parallel lines or arc-shaped or circular.

Preferably, the wedge-shaped surfaces are directly disposed in the graphite electrode or the end face of the graphite electrode, e.g. by milling. The contacting element, which most often consists of copper, is thus brought into direct engagement with the wedge-shaped surfaces of graphite. The work-intensive attachment of a contact plate of, e.g., copper with the corresponding wedge-shaped surfaces can be dispensed with. Therefore, an unnecessary additional material interface is avoided.

Nevertheless, it also falls under the invention if a contact plate that is firmly connected with the surface of the graphite electrode is provided, which comprises the wedge-shaped surfaces according to the invention. Such a plate can consists, for example, of copper. Attachment to the end face of the graphite electrode is carried out, for example, by screwing with conventional threaded screws and cross thread bolts which are inserted into the graphite electrode through cross bores and are used for a uniform distribution of threaded bores over the end face of the graphite electrode. The plate can be pulled against the surface on the end face of the graphite electrode with a large force due this kind of fastening. However, the pressure is not passed on to the carbon-containing material to be graphitized in the furnace.

Preferably, the graphite electrode is formed of several parts, with several
preferably similar and/or cuboid individual electrodes disposed side-by-side next to one another. Preferably, each individual electrode has lateral chamfers, in particular two chamfers, which form the wedge surfaces in such a manner that, respectively, two adjacent chamfers or wedge surfaces of adjacent electrodes form a wedge groove together. This multi-part configuration of the graphite electrode can be used regardless of the design of the connecting element.

Preferably, laterally disposed means acting in opposite directions with regard to force are provided for holding together the individual electrodes, whose direction of force is offset by approx. 90° relative to the separation joint and to the axial direction of movement of the contacting elements.

Preferably, the means for holding the individual electrodes together are such that they become effective while or after the connecting element is pressed against the graphite electrode.

Preferably, all individual electrodes have the same geometry.

Preferably, the wedge angle is selected such that a self-locking action arises, that is, that the wedge cannot slip out from its V-shaped groove due to the opposing frictional forces.

The invention will be described and explained in a non-limiting and exemplary manner with reference to figures.

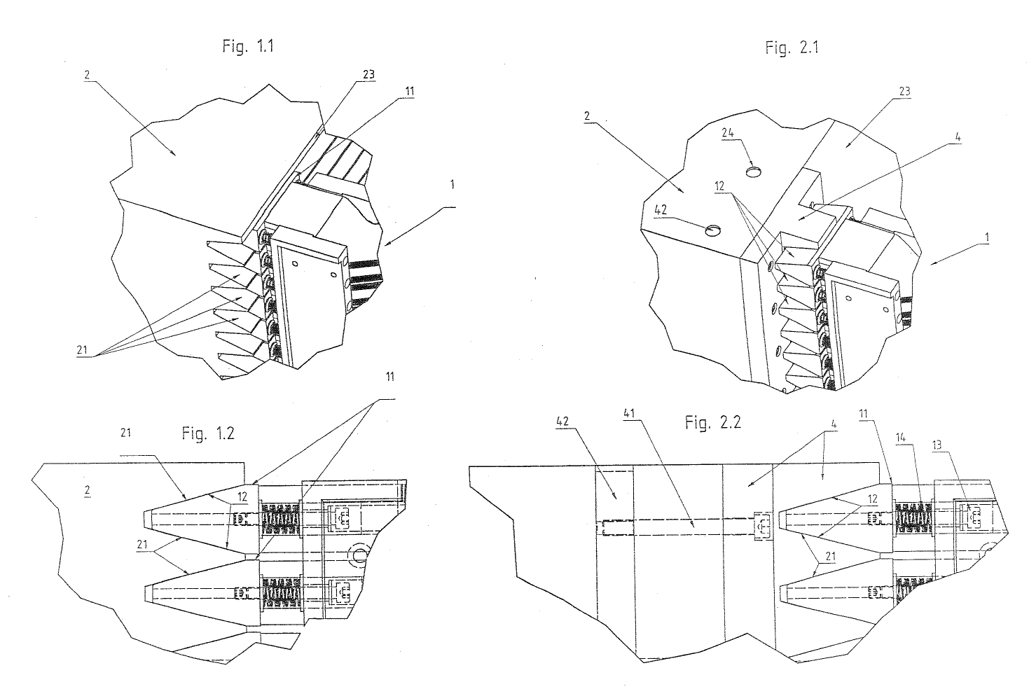

FIGS. 1.1, 1.2 show a cuboid graphite electrode 2 at whose rear end face, which is not shown, the carbon-containing material intended for graphitizing is attached for conversion of amorphous carbon into polycrystalline graphite. The opposite end face 23 comprises wedge-shaped grooves formed by two wedge-shaped surfaces 21. The wedge-shaped grooves extend perpendicularly to the end face 23. An electrical connecting element 1 is pressed against the free end face 23 of the graphite electrode 2 by means of a hydraulic ram not shown. In this case, the electrical connecting element 1 comprises a plurality of separately mounted contacting elements 11 which comprise counter-surfaces 12 that are also arranged in a wedge shape. They can be in engagement with the surfaces 21 of the wedges in order to establish an electrical surface contact. The wedge-shaped contacting element 11 is made of massive copper and is directly connected with a flexible electrical conductor. The latter can consist, for example, of stacked metal foils or a metal mesh or cables.

Each of the contacting elements 11 is individually resiliently mounted in the connecting element 1. During contacting, the spring travel is at least 1 mm. In this case, the minimum spring length is at least ten times of the resulting spring travel, in order to achieve an almost uniform spring force over the required spring travel. Thus, the result for each contacting element is an almost equal contact pressure with the surfaces 21 of the wedge-shaped groove, irrespective of possible displacement of the various wedge-shaped grooves 21, FIGS. 2.1, 2.2 substantially correspond to FIG. 1, but the wedge-shaped grooves 21 are not directly incorporated in the graphite electrode 2. Rather, a contact plate 4—which typically consists of copper—is attached at the free end face 23. This contact plate 4 comprises wedge-shaped grooves 21, which in this case are fitted on it and into which the wedge-shaped connecting elements 11 can be inserted. The attachment of the contact plate 4 to the graphite electrode 2 is carried out, for example, by screwing it on with conventional threaded screws 41 and cross thread bolts 42 which are inserted into the graphite electrode through cross bores 24 and are used for a uniform distribution of threaded bores over the end face of the graphite electrode.

FIG. 3 shows a detailed view of a contacting element 11 with its counter-surface 12, which are arranged in a wedge-like manner. The contacting element 11 is mounted on the outside on two bolts 13 so as to be displaceable. Springs 14 which urge the contacting element 11 in the direction of the wedge are placed on the bolts. The bolts are displaceably mounted in spacers 18 which are connected on the rear with the spacer element 1. The flexible conductors 3 are connected to the contacting element 11 mechanically firmly and with good conductivity, for example by screwing, soldering or welding.

FIG. 4 corresponds to the view from FIG. 3 and only differs from it by the shape of the wedge-shaped contacting element. The latter is slotted in the horizontal plane in such a way that the upper and lower halves of the wedge-shaped contacting element are connected only by a narrow web which serves as a hinge for the compensation of angular misalignments and is capable of conducting a compensating current.

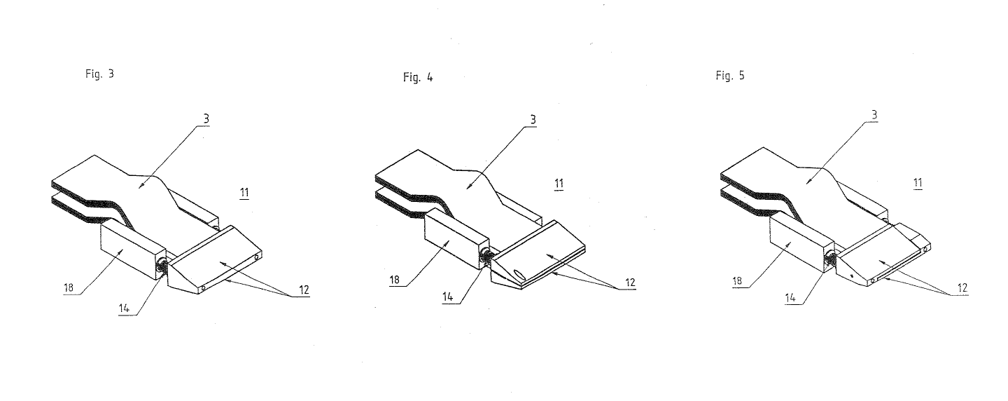

FIG. 5 corresponds to the view from FIG. 4 and only differs from it by the shape of the wedge-shaped contacting element. This consists of two parts—in this case one folded over the other so as to fit the attachment of the bolts—and comprises a hinge instead of a web for compensating the angles of the wedge elements. The hinge can be configured as a separate component in the form of a shaft or of an intermediate element. However, it can also be formed by the particular shape of the top and bottom part of the wedge-shaped contacting element (not shown).

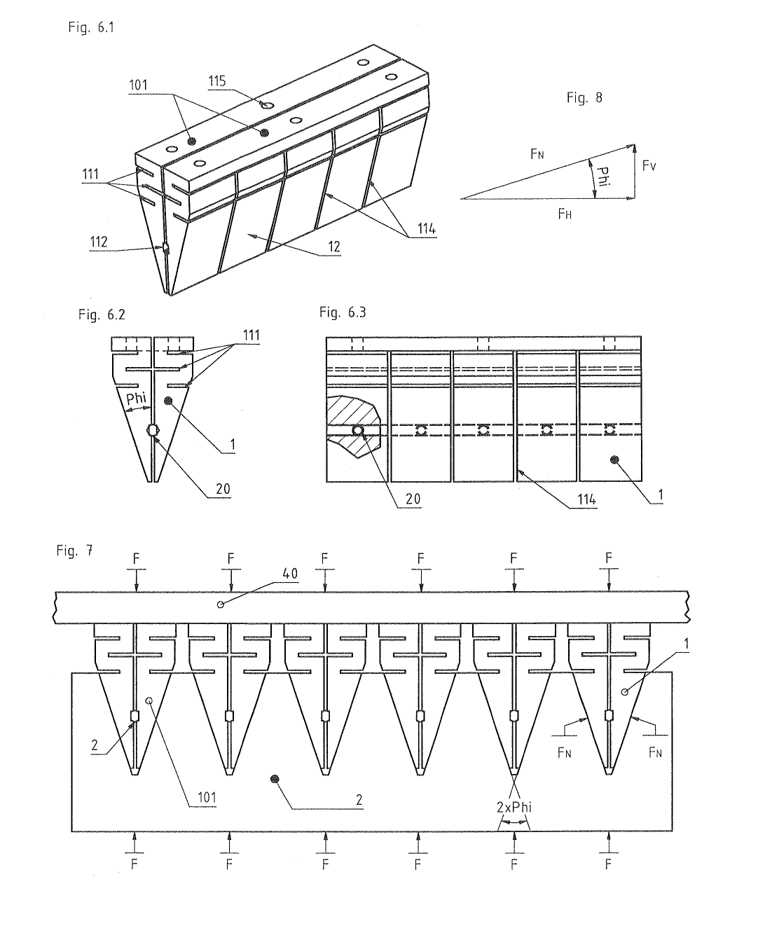

FIGS. 6.1, 6.2, 6.3 show a two-part contact wedge consisting of two individual wedges 101 each configured in such a way that a spring action results in the direction of pressure according to FIG. 7 due to the horizontal slots 111 in the wedge base. Moreover, the horizontal slots 111 permit a springy angular movement and torsional movement of the wedge-shaped tip about the longitudinal axis. In this case, the slots are alternately incorporated over the entire height, from the left and the right and parallel to each other, into the base element of the individual wedges, with the horizontal slots 111, as seen from above, partially superposing one another. This results in a particular pliability in the direction of the slots, i.e. to the right and the left in FIG. 6.2. An improved pliability in all directions, i.e. forwards, backwards, left and right in FIG. 6.2 results if the slots are incorporated alternately from all four sides over the entire height, e.g. from the front, left, rear and right into the base element of the individual wedges. Thus, the wedge element is made of one piece and configured in such a way that its shape is able to assume the function of the springs from FIG. 1.

Separated by vertical slots 114, individual contact surfaces 12 are created which, mutually supported by a ball 20, can move relative to one another in all degrees of freedom.

FIG. 7 shows the individual wedges 101 attached to a pressure plate 40 by means of threaded bores 115 (see FIG. 6.1), which wedges are thus combined to form one or more contact wedges and to which a pressure force F and an electrical current are applied. According to the invention, wedge grooves in a counter-element 2, in this case the graphite electrode, can have manufacturing inaccuracies in a range of unusually large tolerances with regard to angle accuracy, parallelism and depth of grooves without a good electrical contact being jeopardized. In particular in the case of a combination of a pressure plate 40 equipped with individual wedges 101 with several different counter-elements, i.e., for example different graphite electrodes 2, in the case of a fixed power supply unit and several moveable collectors, such as in the case of rotary transfer tables or transfer lines, as well as in the reverse case of a moveable power supply unit and several fixed collectors, as they can be found, for example, in large-scale furnace plants with a cyclical power supply of the fixed individual furnaces, the adaptability of the individual wedges to the counter-geometry present in each case is particularly helpful, because adapting a massive individual wedge to the ideal contact geometry in relation to the counter-element would not be possible by means of abrasion and plastic deformation, because of the frequently changing counter-elements 2.

A surface contact always has a statistically randomly occurring number of contact points between the surfaces which depend on the evenness and the roughness of the surfaces. The more contact points there are, the better the electrical contact and the heat transfer between the components of different potentials which can form, for example, a detachable circuit element.

Because of its spring-like character, the present construction permits, both in the direction of pressure as well as with regard to the mobility of the individual surfaces 12 relative to one another, a formation of contact points that is, statistically seen, “2×(N+1)” times more frequent than in a comparable, single-part, unslotted component, with “N” being the number of vertical slots 114.

FIG. 7 shows a typical assembly of a pressure plate 40, contact wedges 101 and a counter-element 2, in this case the graphite electrode or the contact plate. Due to the arrangement of a number of “M” two-part contact wedges with “N” vertical slots 114, the statistical number of the contact points between the individual wedges 101 and the counter-element 2 is higher by the factor M·2·(N+1) than would be the case in single-part unslotted contact wedges. In the example shown in FIGS. 6.1 and 7, this would be 6·2·(4+1)=60 times more contact points than in the embodiment comprising massive contact wedges. The contact force at the wedge surfaces can be calculated by the wedge angle Phi of the individual wedge by means of the relation Contact Force F_{N}=Pressure Force F_{V}/sin(Phi). The smaller the angle Phi of the individual wedge becomes, the larger the contact force becomes.

If a simple flat contact between the pressure plate 40 and the counter-element 2 is compared, given the same surface ratios and the same pressure force, then the contact force F_{N} is increased by about the factor 2 to 6 in the case of individual wedge angles of 30° to approx. 10°. The statistical probability of the number of contact points rises almost proportionally with an increasing contact force, so that a factor of 1.8 to 5 can be assumed. Compared with the flat large-surface contact, the solution shown, which comprises individual wedges slotted several times, thus offers a contacting which is better by a factor 100 to 300.

FIG. 8 shows the force ration between the normal force F_{N} on the wedge surface, the horizontal component F_{H} and the vertical component F_{V} (pressure force) of the force.

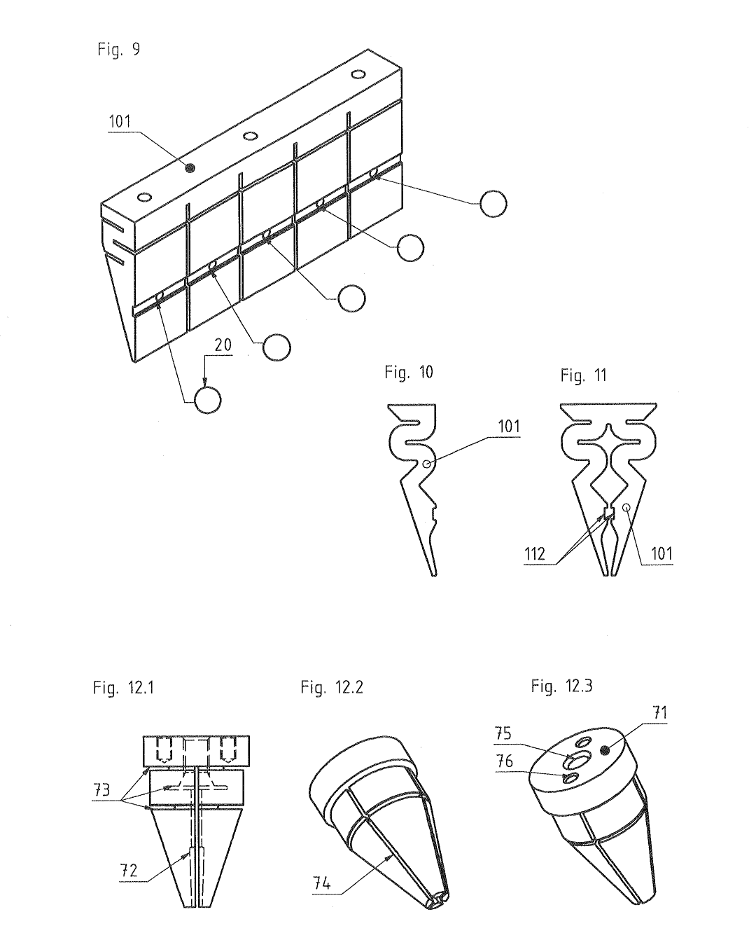

FIG. 9 shows a slotted individual wedge 101 that can be produced from a solid material by simple processing methods such as sawing, milling, boring and thread cutting. This design is suitable for producing a small number of items. No separate components are required for resilient mounting. Moreover, the Figure shows the position of the balls 20 that make it possible for the individual wedges to mutually support each other and to cause the horizontal components of the normal force acting on the surfaces to cancel each other out.

FIG. 10 shows an individual wedge that is optimized, as compared to FIG. 9, for the manufacturing method of extrusion or pultrusion, and which is suitable for the manufacture of greater numbers of items. The horizontal slots 111 extend over the length of the profile and can therefore be produced directly, without any further processing, during extrusion or pultrusion.

FIG. 11 shows a cross section optimized further as compared with FIG. 10, which makes it possible to design the two-part contacting wedge shown in FIG. 6.1 in one piece while maintaining the advantageously described spring properties and the degrees of freedom. This makes it possible to save costs in production and assembly, in particular in the case of very high numbers of items. The balls required can be installed and fixed through the slots 61 in this embodiment by utilizing the spring action of the two legs and with the aid of a simple punched belt as a ball cage (not shown).

FIGS. 12.1, 12.2, 12.3 show a one-piece contact bolt designed, as compared with FIG. 9, as a slotted truncated cone, which is attached on a pressure plate 40 under current by means of a central thread 75 and/or several individual thread bores 76, and into which the current is introduced via the contact surface 71. The tapering shape reduces the cross-sectional surface along the contact surface to the counter-element (not shown) and is preferably designed such that the current distribution along the contact surface is improved, in particular when the counter-element has a significantly lower electrical conductance than the contact bolt. A smaller contact surface is available for the shortest path of the current than for the longer path. Therefore, the current uses the contact surface more uniformly. This is the case, for example, if the counter-element consists of graphite. The counter-element can be produced in a simple manner by means of conical bores. Selection of the angle is ideally based on tools already available for producing tool holders for drilling or milling machines, but any other angles can also be chosen. Peripheral horizontal grooves 73 which are added from the outside or alternately from the outside and the inside are provided as springs in the area of the cone base, and centrally incorporated vertical slots 74, preferably cross-like, are provided. A ball (not shown), which permits the partial wedges separated by the slots 74 to mutually support each other and to cause the horizontal components of the normal forces acting on the surfaces to cancel each other out, is introduced through the bore 72. By widening the slots 74 at the tip of the truncated cone, the bore 72 can be produced in such a way that the result, after drilling and removing the widened area at the end of the bore, is a larger diameter than in the area of the tip of the truncated cone. It is thus ensured that the ball inserted thereafter remains at its intended position.

In the exemplary embodiments, the invention was described with reference to wedge-shaped contacting elements and wedge-shaped counter-elements. Conversely, the contacting element can also be formed as a wedge-shaped groove, of course, and the corresponding counter-element in the graphite electrode as a wedge. Preferably, the shape of the wedge is symmetrical. The invention was described within the context of graphitization, also merely by way of example. The contacting according to the invention of a graphite electrode to a metallic conductor can also be used in the same way in graphite electrodes for melting metals, e.g. from ores, steel from pig iron or scrap metal, nickel from nickel ores or in reduction processes, e.g. in aluminum production.

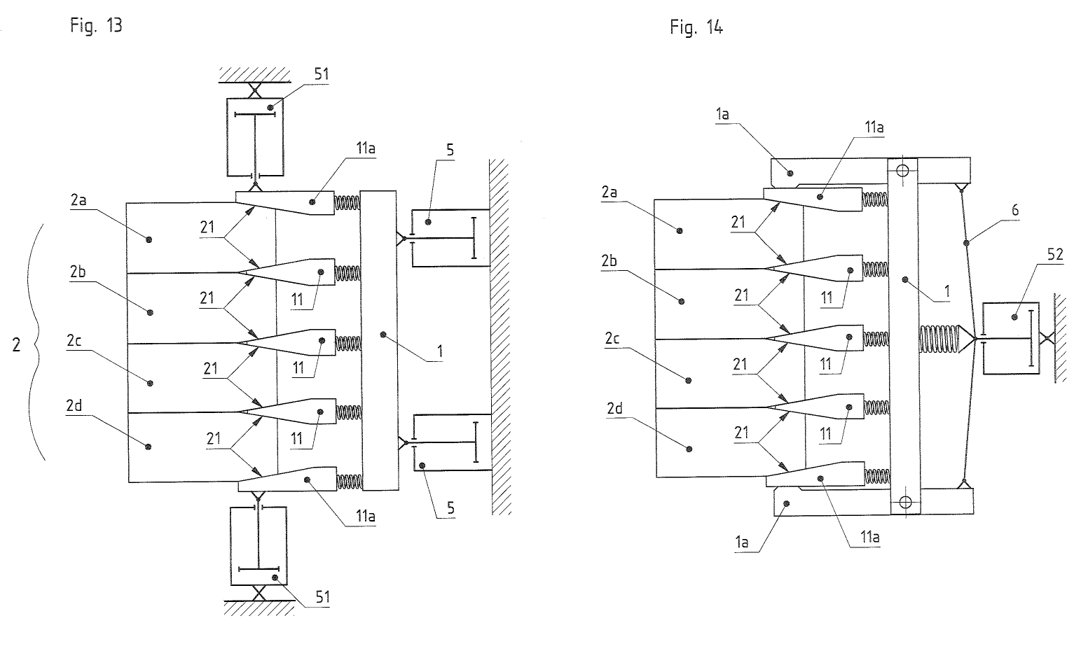

FIGS. 13 and 14 schematically show an alternative embodiment of the graphite electrode 2, which is formed of several parts, in the top view or side view, depending on the orientation of the wedge grooves formed by two wedge-shaped surface 21, respectively. In this case, the electrode 2 is formed of several, preferably similar and/or cuboid individual electrodes 2a-2d disposed side-by-side next to one another. Each individual electrode has lateral chamfers, in particular two chamfers, which form the wedge surfaces 21. Two adjacent chamfers or wedge surfaces 21 of adjacent electrodes, respectively, form a wedge groove together. The bottom of the groove of the wedge groove lies in the separation joint between two adjacent individual electrodes. In the view shown, there are four adjacently disposed individual electrodes. In addition, however, several such rows can also be present one on top of the other, i.e. extending in the direction of the depth of the view.

The separate individual electrodes 2a-2d, during the necessary processing of the lateral surfaces so as to obtain the required nominal dimensions, can receive in a simple manner the one or several chamfered wedge-shaped surfaces 21, which can later, during assembly, form the wedge groove or V-shaped contact surfaces for electrical contacting. This multi-part configuration of the graphite electrode can be used regardless of the design of the connecting element 1 in FIGS. 13 and 14.

The connecting element 1 carries a plurality of wedge-like contacting elements 11 and substantially corresponds to the above-mentioned exemplary embodiments. The contacting elements 11 can also be configured as was already described above, and are resiliently connected with the connecting element 1, which is indicated by the springs. Due to the multi-part configuration of the graphite electrode 2, the two-part configuration of the contacting element can possibly dispensed with, because the individual parts 2a-2d can absorb settlements if necessary. The contacting elements 11 can therefore be rigid and/or massive and thus be easier to produce.

The electrical terminals on the resiliently mounted contacting elements 11 and the workpieces of raw coal intended for graphitization are not shown.

Because the separation joints are subjected to tensile loads by the contacting elements during contacting and would form an opening gap, lateral means 51, 1a acting in opposite directions for holding together, e.g. in the form of hold-down devices, are provided, whose direction of force is offset by approx. 90° relative to the separation joint and to the axial direction of movement of the contacting elements 11.

These means can be static, e.g. a vise. Preferably, however, dynamic means are proposed that become effective while or after the connecting element 1 is pressed against the graphite electrode. The latter case has the following advantage: in order to build up a large contact pressure between the wedge surfaces 21 and the surfaces of the contacting elements 11 abutting them, the contacting elements can at first be pushed with a comparably small contact force in the axial direction between the wedge surfaces 21. At that point in time, the contact pressure is still small and not optimal for conducting current. It is only then that the means for holding together 51, 1a become effective. Because of the flat wedge shape of the contacting elements 11, they press the wedge surfaces 21 against the surface of the contacting elements 11. The intended high contact pressure builds up, without the large axial contact forces known from the prior art. The individual electrodes 2a-2d that lie next to one another can be pressed together sufficiently by the means for holding together, because of the separation joint. Depending on the design, a single-part graphite electrode can also be pressed together sufficiently.

FIG. 13 shows that the means for holding together 51 can be formed separately, e.g. as an additional pressure cylinder. It exerts a lateral pressure which can be applied independently from the force for pressing the connecting element 1 against the graphite electrode. If the lateral pressure cylinders are mounted moveably, this type of contacting, utilizing the self-locking action, can be used for the axial return movement of the graphite electrode together with the connecting element if the lateral pressure is removed only after the return movement has been executed.

FIG. 14 shows that preferably the means 1a for holding together can also be formed dependently, e.g. via a lever and spring construction. The latter exerts a lateral pressure which can be applied dependent on the force for pressing the connecting element 1 against the graphite electrode. In the example, an axially acting force is at first applied to the connecting element 1 via the spring, the force pushing the contacting elements 11 in the axial direction between the wedge surfaces 21, at first with a comparatively small contact force. It is only when the spring is compressed that the means for holding together 1a, acting via a linkage system 6 and levers, become effective. Based on common considerations, the person skilled in the art is capable of designing the springs, linkage system, relationships of the levers and angles of the construction in such a manner that a sufficient contact pressure is achieved at a small contact force. The advantage of this construction lies in the fact that only one means for exerting pressure must be used in the axial direction and that the timing is the result of purely mechanical control by means of the lever and spring.

Moreover, FIGS. 13 and 14 show that contacting elements 11a on the edges abut the graphite electrode 2, with the means for holding together 51, 1a acting on the contacting elements 11a on the edges. The result is a uniform introduction of current. Moreover, identical individual electrodes 2a-2d can be produced because the electrodes 2a, 2d on the edges do not require a different geometry.

A different or alternative measure for achieving independence of the contact pressure from the axial contact force is achieved if the wedge angle is selected such that a self-locking action arises, that is, that the wedge cannot slip out from its V-shaped groove due to the opposing frictional forces. Therefore, the axial contact force can even cease to apply or become negative without the contact pressure abating to a relevant extent. In the exemplary embodiment from FIG. 13, if the pressure cylinders 51 are mounted moveably, this makes it possible to move the graphite electrode 2 axially together with the adhering contacting element 1 so long as the means for pressing together are effective. This is the case at very small wedge angles PHI, preferably smaller than 5°. The maximal angle is determined in this case by the present or also by the achievable friction conditions and must be established by the person skilled in the art. Self-locking action arises if the tangent of PHI is smaller or equal to the friction coefficient μ. In the case of small angles, the tangent of the angle equals aproximally the angle (in radian).

1. Graphite electrode comprising an electrical connecting element,
characterized in that
the graphite electrode comprises a plurality of wedge-shaped surfaces;
the connecting element comprises a plurality of contacting elements with wedge-shaped counter-surfaces, wherein the surfaces and counter-surfaces are configured and arranged such that the surfaces and counter-surfaces are in engagement in order to establish a surface contact, and that current can be introduced into the graphite electrode via the connecting element.

2. Electrode according to claim 1, characterized in that the contacting elements are mounted, individually or in groups, resiliently in the connecting element such that settlements, thermally or tolerance induced changes in position of the graphite electrode or of the connecting element can be compensated, with preferably a clearance about all axes of at least 1° being provided.

3. Electrode according to claim 2, characterized in that a spring pressure acts in the direction of wedge taper formed by the wedge-shaped counter-surfaces.

4. Electrode according to claim 2, characterized in that a massive integrally formed wedge forms the contacting element.

5. Electrode according to claim 2, characterized in that the wedge-shaped surfaces or counter-surfaces, respectively, are arranged in a wedge angle of between 5-45°.

6. Electrode according to claim 1, characterized in that a flexible electrical conductor is respectively connected with one of the contacting elements or one of the groups of contacting elements, respectively.

7. Electrode according to claim 2, characterized in that the graphite electrode has an end face and the wedge-shaped surfaces are disposed on the end face of the graphite electrode.

8. Electrode according to claim 7, characterized the wedge-shaped surfaces are disposed on the end face of the graphite electrode in such a way that, taking into account the specific resistance of graphite, the result is a comparable electrical current in operation for all contacting elements, in particular in a range of +/−20%.

9. Electrode according to claim 7, characterized in that a contact plate is firmly connected with the end face of the graphite electrode, with the plurality of wedge-shaped surfaces being provided on the contact plate facing away from the graphite electrode.

10. Electrode according to claim 7, characterized in that the end face of the graphite electrode directly forms the wedge-shaped surfaces.

11. Electrode according to claim 1, characterized in that the contacting element comprises several individual wedges having wedge bases with horizontal slots in the wedge bases acting as springs.

12. Electrode according to claim 1, characterized in that the electrode is formed of several parts, with several individual electrodes disposed side-by-side next to one another.

13. Electrode according to claim 12, characterized in that, laterally of the electrode, means acting in opposite directions are provided for holding the individual electrodes together.

14. Electrode according to claim 1, characterized in that the wedge-shaped surfaces or counter-surfaces, respectively, are arranged in a wedge angle selected such that a self-locking action arises.

15. Furnace for graphitizing carbon-containing materials for the conversion of amorphous carbon to polycrystalline graphite, comprising two graphite electrodes according to claim 1, wherein the electrodes have end faces, the carbon-containing material is disposed between the two graphite electrodes and the electrical connecting elements are disposed at the end faces on the graphite electrodes.

16. Electrode according to claim 2, characterized in that the clearance is at least 2°.

17. Electrode according to claim 12, characterized in that the clearance the individual electrode have similar cuboid shapes.

18. Electrode according to claim 12, characterized in that the contacting elements are mounted, individually or in groups, resiliently on the connecting element, the wedge-shaped surfaces or counter-surfaces, respectively, are arranged in a wedge angle of up to about 45°, and a flexible electrical conductor is respectively connected with one of the contacting elements or one of the groups of contacting elements, respectively.
